(19) United States
(12) Patent Application Publication
(10) Pub. No.: US 2017/0044055 A1
(43) Pub. Date: Feb. 16, 2017

(54) THIN SHEET GLASS COMPOSITE AND METHOD OF STORING THIN SHEET GLASS

(71) Applicant: TESA SE, Norderstedt (DE)

(72) Inventors: Klaus Keite-Telgenbüscher, Hamburg (DE); Tanita Czeki, Hamburg (DE); Christian Schuh, Hamburg (DE)

(21) Appl. No.: 15/306,174

(22) PCT Filed: Apr. 9, 2015
(86) PCT No.: PCT/EP2015/057665

§ 371 Date: Oct. 24, 2016

(30) Foreign Application Priority Data
Apr. 25, 2014 (DE) 10 2014 207 837.7

(51) Int. Cl. C03C 17/42; C03C 17/32; B65H 18/28; C03C 17/00

(52) U.S. Cl. CPC C03C 17/42; C03C 17/002; C03C 17/328; C03C 17/007; C03C 17/32; B65H 18/28; C03C 2217/76; C03C 2217/78; C03C 2218/32; C03C 2218/15; B65H 2801/61

(57) ABSTRACT

The invention relates to a method of storing a thin sheet glass film (10). According to the invention, the thin sheet glass film (10) is held at two sides, at least one side of the thin sheet glass film (10) is coated over its entire surface with a fluid coating material (20) comprising at least one drying agent, the coating material (20) sets to form a solid polymeric coating, and the coated thin sheet glass film (10) is rolled up for storage.

The invention relates to a method of storing thin sheet glass and a rolled up thin sheet glass composite.

Optoelectronic devices are being used in commercial products with increasing frequency or are about to be introduced on the market. Such devices comprise inorganic or organic electronic structures such as organic, metal organic, or polymeric semiconductors or combinations thereof. Depending on the desired application, the corresponding product may be stiff or flexible, with there being an increasing demand for flexible devices. Such devices are often produced by means of printing processes such as relief printing, gravure printing, screen printing, flat printing, or by means of so-called “non-impact printing” processes such as thermal transfer printing, laser jet printing, or digital printing. In many cases, however, vacuum processes such as chemical vapor deposition (CVD), physical vapor deposition (PVD), plasma-enhanced chemical or physical deposition (PECVD), sputtering, (plasma) etching, or vapor plating are used. Structuring is carried out as a rule using masks.

Examples of optoelectronic applications that are already commercially available or have significant market potential include electrophoretic or electrochromic structures or displays, and organic or polymeric light-emitting diodes (OLEDs or PLEDs) in advertising or display devices or as illumination, and the thin sheet glass films can also be used for covering or encapsulation of electroluminescent lamps, light-emitting electrochemical cells (LEECs), organic solar cells such as dye or polymeric solar cells, inorganic thin-layer solar cells, for example based on silicon, germanium-copper, indium or selenium, or perovskite solar cells or organic field effect transistors, organic switching elements, organic optical amplifiers, organic laser diodes, organic or inorganic sensors, or organic or inorganic-based RFID transponders.

The thin sheet glass films are provided after rolling onto rolls. Because of the risk of stress corrosion cracking and for mechanical stabilizing, the thin sheet glass film must be protected and stabilized with a protective film.

Stability-retaining measures for the prevention of glass corrosion are of vital importance in the widespread application of thin sheet glass to rolls. Glass corrosion is a phenomenon that causes cracks in stressed silicate glasses to become larger. Corrosion occurring under tensile stress or internal stress is referred to as static fatigue or stress corrosion cracking. It results from the slow propagation of microcracks already present in the material.

From a chemical standpoint, the interaction between the stressed molecules in the crack tips of the glass and the water molecules from the ambient air is responsible for stress corrosion cracking.

Quartz glasses composed of silicon oxides are highly homogeneous. The silicates are configured in tetradic units and joined at their corners by silicon oxide bonds. On an atomic scale, the silicon oxide bonds carry the stresses in material, and the cleavage of these silicon oxide bonds is decisive and responsible for crack propagation in the material, referred to as stress corrosion cracking. Highly-concentrated stress fields are produced in the tips of the cracks in the quartz glass. Approximate values show that the bridging bonds, or the distance between the silicon and oxygen atoms in the silicon oxide bond, are subject to extension of more than 20%. The effect of this elongation on the bridging silicon oxide bond can be seen as reduced bond overlapping. The silicon and oxygen atoms of the stressed bond thus have increased availability for bonding with other atoms. In particular, this leads to an interaction of the stressed bridging bond at the crack tip with a water molecule from the environment. The theory of stress corrosion cracking is also presented in the report “Stress corrosion mechanism in silicate glasses” (Matteo Ciccotti, Journal of Physics D: applied Physics Vol. 42, 2009).

In a first step, a water molecule from the environment attaches to a stressed bridging Si—O—Si-bond in the crack tip. The water molecule first attaches by forming a hydrogen bond between the H (of the water) and the O (oxygen from the Si—O—Si bond) and then attaches to the silicon atom by interaction of the free electron pairs of the O (of the water) with the silicon. The orbital interaction of the free electron pair may involve van der Waals forces or covalent bonding with unoccupied Si orbitals.

In a second step, a concerted reaction occurs. In this reaction, a proton transfer to the SO (Si—O) occurs simultaneously with an electron transfer of the O (of the water) to the silicon. As a result of this reaction, two new bonds are formed, specifically one between the O (of the water) and the silicon and one between the H (of the water) and the O (of the Si—O).

In a third step, a bond forms between the O (of the water) and the transferred H (of the water), and Si—OH groups form on the surface. As the hydrogen bond is relatively weak, this step is expected immediately after the proton transfer. This is an ongoing reaction in the glass that takes place between the glass, which is under stress, and the surrounding water. This mechanism does not occur in the same or similar form in pure silicate glasses.

Sheet glass films rolled onto rolls in particular are subjected to stress, which promotes ongoing crack formation. Various methods and devices are known from prior art that allow thin sheet glass to be stabilized.

WO 2011/084323 A1 describes a polymer glass laminate for stabilizing of thin sheet glass and sealing of microcracks. In this case, microscopic structural defects are sealed. An alkoxysilane-modified polyolefin seals the microcracks on contact with the glass. In this case, the microcrack is filled, and the permeation rate at the sealed site is at least 90% of the permeation rate of the undamaged material. Irreversible bonding of the modified polyolefin to the glass takes place. The alkoxysilane-modified polyolefin layer can be applied from a solution or extrusion-coated from a melt, but in this case, the preferred lamination of a preformed layer onto the glass is disclosed. A drawback is the high stress on the thin sheet glass during lamination exerted by pressure and temperature, which increase the risk of breaks in the glass. The modified polyolefin layer has no drying agent.

U.S. Pat. No. 6,815,070 B1 describes a glass-plastic composite for the stabilizing of thin sheet glass. Coating of the thin sheet glass is carried out using liquid polymers. Application of the polymer layer is carried out by spinning, spraying, pouring on, rolling on, or dipping. The encapsulation of OLEDs is described as an application. No functionality of the polymer layer beyond mechanical stabilizing is disclosed.

WO 2005/110741 A1 describes various processes for producing glass-polymer laminates. Polymers are used in the form of films, melts, solutions, and compositions. The polymers are applied by coating, spraying, casting, dipping, lamination, and spray coating. Here as well, no functionality of the polymer layer beyond mechanical stabilizing is disclosed.

DE 1955853 A1 discloses a composite of a glass film with a one or two-sided plastic coating. The purpose is to provide a composite material that shows impermeability to gases and water vapor and high flexibility even under the effects of heat. Production techniques are disclosed such as the extrusion of polymers or the lamination of films. In some cases, the films have adhesives and adhesion promoters and are pressed while applying heat. The composite serves exclusively to mechanically stabilize the glass film.

EP 2363383 A1 discloses a laminate of thin glass and reinforcing intermediate layers of thermoplastic resin. The resins are chemically bonded to the glass by adhesion promoters. These are O—H terminated polymers that are bonded to the glass via the epoxy groups of the adhesion promoter. The reinforcing property of the resin is thus directly adjacent to the glass and is not impaired by soft PSAs. The glass is coated on both sides with adhesion promoters and resin, producing a complex structure.

JP 2008273211 discloses the reinforcement of a thin sheet glass, preferably measuring 10 to 70 μm, by means of polymer, preferably measuring 10-200 μm, in some cases also with adhesion promoters or adhesives. As glass becomes more flexible as its thickness decreases, but its water and gas permeability increases, the resin coating of the thin sheet glass is intended to provide a good barrier for protecting encapsulated, preferably organic electronic components. In this case as well, the polymer layer mechanically stabilizes the thin sheet glass. Only lamination is disclosed as a method for applying the polymer reinforcement.

DE 102 00 131 A1 describes flexible composites of glass with at least one polymer-reinforced side. Various multilayer structures are disclosed, with a plurality of glass and polymer layers being provided in a laminate in this case as well. The layers are bonded together with adhesion promoters, which can also be pressure sensitive adhesives or compounds with silane groups. An elastic composite is formed by the succession of layers. In this case as well, only the mechanical stabilizing of the glass by a polymer film is described. Permeation-inhibiting polymers are preferred.

EP 2204355 A1 describes various processes for producing a thin sheet glass with a polymer coating for stabilizing the thin sheet glass. Various processing methods for applying the polymer are disclosed. Coating takes place immediately after glass production or during glass production in order to prevent damage to the thin sheet glass from the outset. Coating is preferably carried out by lamination of a polymer film. The polymer film can also be cured after lamination. The polymer layer stabilizes the thin sheet glass. In this case as well, only mechanical stabilizing of the polymer film is described.

WO 2008/093153 A1 describes various methods for the production of thin sheet glass. These methods are intended to allow extremely wide glass sheets to be produced. A tubular glass melt is blown through which the glass extends, and the resulting preform is cut into a ribbon. The ribbon is drawn by means of rollers. An in-line polymer coating of polyamide and acrylamide is also mentioned. On the one hand, coating of the glass preform before blowing is disclosed, with the polymer then being blown to expansion as well, and on the other hand, coating of the resulting thin sheet glass cylinder is also disclosed. The glass tube passes through a coating ring and is coated with a liquid polymer in a thickness of 10 to 150 μm. The polymer protective layer is intended to protect the glass during use, particularly during cutting. A drawback is that functionality of the polymer other than mechanical stabilizing is not disclosed.

US 2013/0196163 A1 describes the application of a fluid coating material of acrylate oligomers which is cured after application by means of UV irradiation. The cured layer is an adhesive layer having a layer thickness of less than 10 μm that is used for bonding to further layers.

Various methods for the coating of thin sheet glass are therefore known from prior art which make it possible to mechanically stabilize a thin sheet glass film. However, the problem of self-propagating microcracks under stress remains.

The object of the present invention is to provide a method for storing a thin sheet glass film which allows longer storage times under stress in a rolled up state and a rolled up thin sheet glass composite which allows longer storage of a rolled up thin sheet glass film.

The object is achieved in its first aspect by means of a method mentioned above having the features of claim 1 and in its second aspect by means of the aforementioned rolled up thin sheet glass composite with the features of claim 10.

First, a film is understood to refer to a sheetlike structure whose dimensions in one spatial direction, namely thickness or height, are significantly smaller than in the two other spatial dimensions which define the main extension, namely length and width. The film can be configured in a simply cohesive manner, or may be pierced. It may consist of a single material or may be composed of various materials in different areas. The film may show a constant thickness over its entire surface area or may have differences in thickness. The film may consist of a single layer of a plurality of layers that may be arranged congruently or may at least partially not overlap.

A thin sheet glass film is understood to refer to a film with a thickness of 15 to 200 μm, preferably 20 to 100 μm, preferably 25 to 75 μm, and particularly preferably 30 to 50 μm.

The thin sheet glass film is preferably a borosilicate glass, for example D 263 T ECO manufactured by Schott, and alkali silicate glass, or an aluminium borosilicate glass such as the AF 32 ECO, also manufactured by Schott.

Preferably, the UV transmission of alkali-free thin sheet glasses such as AF 32 ECO is higher than that of alkali-containing thin sheet glasses. Initiators with absorption maxima in the UC-C range can therefore be more advantageously used as UV curing adhesives, allowing the stability of the uncrosslinked adhesive to be increased compared to daylight.

Alkali-containing thin sheet glasses such as D 263 T ECO show a higher thermal expansion coefficient and are therefore compatible with possibly polymeric components of the adhesive or carrier material layer or an optoelectronic device to which the thin sheet glass composite according to the invention is applied and whose components are encapsulated by the thin sheet glass composite.

The thin sheet glasses may be produced by the down-draw process, as disclosed for example in WO 00/41978 A1, or by methods such as those disclosed in EP 1832558 A1.

Thin sheet glass films are preferably provided in the form of rolled-up bands. Such thin sheet glass films are marketed under the brand name Willow® glasses by Corning. The thin sheet glass films can be favorably laminated together with band-shaped adhesives, for example for the encapsulation of electronic structures, as described in DE 102008062130 A1, DE 102008047964 A1, DE 102008037866 A1, and DE102008060113A1, as well as in DE 102010043866 A1, DE 102010043871 A1, DE 102009036970 A1, or DE102008061840 A1.

According to the invention, the stress corrosion cracking of the rolled up thin sheet glass film described above is counteracted by water by holding the thin sheet glass film at two sides in such a way that at least one side of the thin sheet glass film is coated over its entire surface with a fluid coating material, which comprises at least one drying agent, the coating material directly sets on the at least one side of the thin sheet glass film, preferably a polymeric coating, and the coated thin sheet glass film is rolled up for storage. Preferably, the entire setting process takes place on the at least one side of the thin sheet glass film.

As a result of coating with a fluid coating material and its subsequent setting, the thin sheet glass film is preferably subjected to only minor or virtually no mechanical stresses such as those occurring in lamination due to pressure and temperature. The invention therefore counteracts the formation of cracks during the coating process.

Because of the inclusion of a drying agent in the coating material, a tight contact between the thin sheet glass film side and the drying agent is produced after setting.

Advantageously, the drying agent binds water that has penetrated the thin sheet glass composite, thus preventing propagation of stress corrosion cracking.

According to the invention, the layer containing the drying agent is preferably applied flat to the radial outer side of the rolled up thin sheet glass film and is thus in close contact with the side subjected by the bending within the thin sheet glass film to strong tensile stress. The term ‘applied flat’ means that an essentially closed film is produced that has no intentional small-scale openings such as a perforation or printing raster.

With respect to the geometry of the thin sheet glass film, however, partial areas of the coating may be kept open. Therefore, ‘flat’ does not mean that the entire surface of the thin sheet glass band or section must be coated. For example, partial areas on the edge may be left uncoated for application of an edge protector. Particularly preferably, the layer containing the drying agent is applied over the entire surface of the radial outer side of the rolled up thin sheet glass film. In this case, the entire surface of the thin sheet glass band or section is coated.

Here, the radial outer side is to be understood as referring to the side of the thin sheet glass which in section is perpendicular to the longitudinal direction of the roll onto which the thin sheet glass is rolled, and in a radial direction constitutes the outer side of each of the film layers of the roll. In the rolled up state, the radial outer side of the thin sheet glass film is subjected to greater intrinsic tensile stress than the radial inner side of the thin sheet glass film, which as a rule is under compressive stress. The radial outer side is therefore more susceptible to stress corrosion cracking than the radial inner side of the thin sheet glass film.

All known materials that can be coated from a fluid phase and that set into a solid polymer coating can be used as coating materials. The coating materials may, for example, be in the form of a monomer, a solution, a dispersion, or a melt.

A measure of the flowability of the fluid coating material is its viscosity.

Viscosity can be determined according to DIN 53019, specifically if the viscosity of the fluid coating material is less than 10³ Pa·s. A viscosity of less than 10⁸ Pa·s is referred to as fluid. The viscosity is measured in a cylinder rotation viscometer with a standard geometry according to DIN 53019-1 at a measuring temperature of 23° C. and a shear rate of 1×s⁻¹.

Alternatively, the viscosity is determined according to ISO 6721-10, specifically if the viscosity of the fluid coating material is greater than or equal to 10³ Pa·s. The viscosity is determined in an oscillatory shear experiment (dynamic mechanical analysis, DMA) under torsional loading at a temperature of 23° C. and a frequency of 1 rad/s. The test is described in detail in ISO 6721-10. It is carried out in a shear rate-controlled rheometer under torsional loading using a plate-plate geometry with a plate diameter of 25 mm.

The viscosity is preferably grater than 1 mPa·s, and particularly preferably greater than 10 mPa·s. Below these specified viscosities, there is a risk that the fluid coating material will run during coating.

More preferably, the viscosity is less than 10⁵ Pa·s, and particularly preferably less than 10 Pa·s. At higher viscosities, it is difficult to achieve a uniform coating.

In order to adjust the viscosity of the coating material, known rheologically effective additives can be added to the coating material, i.e. Newtonian and non-Newtonian thickeners, silicon-based flow improvers, or flow improvers not containing silicon. Additives are described, for example, in Bodo Müller, “Additive kompakt,” Hanover; Vincentz Network GmbH & Co KG, 2009.

The fluid coating material, for example, may be in the form of a solution, a dispersion, or a melt. Examples of coating materials suitable for this purpose are polymers obtainable by radical polymerization, polycondensates such as polyester, or polyadducts such as polyurethane, polyimide, or polyamide. Hybrid inorganic-organic coatings, for example sol-gel coatings, are also possible and are included in the scope of the invention.

In another preferred embodiment of the method according to the invention, the structural components of the polymers are first applied, for example radical polymerizable compounds (monomers) or prepolymers formed therefrom. In application of monomers, polymerization and crosslinking take place on the glass film surface, and in application of prepolymers, crosslinking takes place on the glass film surface. The structural components may be present in pure form, as a solution, as a dispersion, or as a melt.

Preferably, polymerization and/or crosslinking is activated by heat or high-energy irradiation, for example NIR light and/or UV light.

Particular examples of radical polymerizable polymers formed by the above polymerization and/or crosslinking include those consisting to more than 60 wt. %, and particularly preferably to more than 80 wt. %, of monomers with at least one acryl or methacryl group. These are also referred to as polyacrylates.

In principle, polymers may be used to carry out the method according to the invention that constitute conventional lacquer systems, particularly dual-component polyurethane lacquers, aminoplast resin crosslinkable backing lacquers, acid-curing melamine resins, epoxide resins, and UV curable lacquers, for example based on monomeric and/or oligomeric acrylic unsaturated substances. Sol-gel lacquers are also possible. For applications in which high temperatures and strong chemical stresses occur, polyimides and solutions of polyimide-forming precursors are also used.

Polymer layers are preferably formed from polymers that are cured by high-energy irradiation, particularly UV irradiation, particularly the polyacrylates described above. In this case, curing of the starting compounds of the polyacrylates (monomers, oligomers, and prepolymer) with irradiation-curing groups, particularly acryl and methacryl groups, is preferably carried out after coating using electron beam or UV irradiation.

Polymer layers of pre-gelled PVC plastisols or aromatic polyimides can also be used. Moreover, polymer layers of halogen-containing polymers, particularly polyvinylidene chloride, may also be used.

Preferably, inorganic-organic hybrid materials can also be used, such as sol-gel lacquers in which, as a rule, structural components are applied to the glass film in a fluid phase and allowed to set there. Examples of such coatings are described for example in H. Schmidt, “Modification of Glass Surfaces by Multifunctional Chemical Coatings”, in: Fundamentals of Glass Science & Technology, 3rd ESG Conf., Würzburg, Germany, 1995.

In a further preferred embodiment of the method according to the invention, the polymeric coating material shows a particularly high water vapor permeation barrier (WVTR<50 g/m²×day, and preferably <20 g/m²×day).

In this case, one should mention as preferred coatings acrylate lacquers crosslinked by irradiation, as presented in J. Oliver: Influences on Barrier Performance of UV/EB Cured Polymers; RadTech Conference, USA, 2010. Coatings based on polyvinylidene dichloride (PVdC) are preferred. Such coating polymers are marketed for example under the brand names IXAN by Solvay and Saran by Dow. Even more preferable are solutions of synthetic rubbers such as polyisobutylene.

The characteristic of setting is understood to mean that the fluid coating material changes to a solid phase, thus increasing in cohesive strength and imparting to the coating its physical and chemical properties. Setting can take place by means of physical processes, such as gel formation, hydration, cooling, evaporation of volatile components and/or chemical reactions such as polymerization, crosslinking, oxidation, and vulcanization.

The following setting mechanisms, which can take place at normal or elevated temperature, can be mentioned as examples:
evaporation or cooling off of water or organic solvents, for example solvents, adhesives, dispersion adhesives
gelatinization (for example plastisols)
reaction under exclusion of air and metal contact (for example, anaerobic adhesives)
reaction due to humidity (for example cyanoacrylates, single-component polyurethanes)
reaction due to application of heat (for example single-component reactive adhesives)
reaction due to radiation effects (for example, UV or electron-beam-cured acrylates)
reaction after bringing into contact of two or a plurality of components (for example, cold- and hot-curing reactive adhesives)
evaporation or venting of organic solvents and subsequent reaction of two components (for example, solvent-containing reactive adhesives).

In physically setting systems, as a rule, the coating molecules are already in a macromolecular end state at the time of application. Chemical reactions dependent on the parameters of temperature and time no longer take place. Final hardness is reached immediately after the physical setting processes are completed. In chemically reacting systems, the final hardness and the mechanical behavior of the material are functions of time and temperature which are specific to the respective curing mechanism.

A drying agent is understood here to refer to a substance that is capable of absorption (sorption) of water. Sorption of water by the drying agent can take place for example by absorption or adsorption, and adsorption can take place in the form of both chemisorption and physisorption. The drying agent could therefore also be referred to as a sorbent or sorption agent.

According to the invention, therefore, the rollable thin sheet glass composite can, by means of the drying agent, remove water from the thin sheet glass film, and by means of the thin sheet glass film and/or the coating material layer, can absorb penetrating water. Examples of suitable drying agents are salts such as cobalt chloride, calcium chloride, calcium bromide, lithium chloride, lithium bromide, magnesium chloride, barium perchlorate, magnesium perchlorate, zinc chloride, zinc bromide, aluminum sulfate, calcium sulfate, copper sulfate, barium sulfate, magnesium sulfate, lithium sulfate, sodium sulfate, cobalt sulfate, titanium sulfate, sodium dithionite, sodium carbonate, sodium sulfate, potassium disulfite, potassium carbonate, and magnesium carbonate; layered silicates such as montmorillonite and bentonite; metal oxides such as barium oxide, calcium oxide, iron oxide, magnesium oxide, sodium oxide, potassium oxide, strontium oxide, aluminium oxide (activated alumina), and titanium dioxide; further, carbon nanotubes, activated carbon, and phosphorus pentoxide; easily oxidizable metals such as iron, calcium, sodium and magnesium; metal hydrides such as calcium hydride, barium hydride, strontium hydride, sodium hydride and lithium aluminum hydride; hydroxides such as potassium hydroxide and sodium hydroxide; metal complexes such as aluminium acetylacetonate; further, silicic acids such as silica gel; diatomaceous earth; zeolites; moreover, organic absorbers, for example polyolefin copolymers, polyamide copolymers, PET copolyesters, anhydrides of simple and multiple carboxylic acids such as acetic anhydride, propionic anhydride, butyric acid anhydride, or methyltetrahydrophthalic anhydride, or further hybrid polymer-based absorbers, which are usually used in combination with catalysts such as cobalt; carbodiimides; further organic absorbers such as weakly crosslinked polyacrylic acid, polyvinyl alcohol, ascorbates, glucose, gallic acid, or unsaturated fats and oils.

According to the invention, mixtures of two or a plurality of drying materials may also be used.

Here, drying agents expressly are not understood as referring to silanes, but silanes serve as adhesion-strengthening agents, as silanes chemically react with the glass surface and are therefore used as adhesion-strengthening agents for bonding to glass. A further layer bonded to the thin sheet glass film in this manner could not be detached again from the thin sheet glass film without destroying it. Particularly preferably, the drying agent is selected from the group comprising cobalt chloride, calcium chloride, calcium bromide, lithium chloride, lithium bromide, magnesium chloride, barium perchlorate, magnesium perchlorate, zinc chloride, zinc bromide, aluminium sulfate, calcium sulfate, copper sulfate, barium sulfate, magnesium sulfate, lithium sulfate, sodium sulfate, cobalt sulfate, titanium sulfate, sodium carbonate, sodium sulfate, potassium carbonate, zeolites, calcium, magnesium, barium oxide, calcium oxide, magnesium oxide, sodium oxide, potassium oxide, strontium oxide, activated carbon, phosphorus pentoxide, calcium hydride, barium hydride, strontium hydride, sodium hydride and lithium aluminium hydride, potassium hydroxide, sodium hydroxide, acetic anhydride, propionic anhydride, butyric anhydride, methyltetrahydrophthalic anhydride and carbodiimides, or mixtures of two or a plurality of the aforementioned substances. These materials show a high sorption capacity with respect to water.

Carbodiimides are understood to refer to compounds of the general formula R¹—N═C═N—R², wherein R¹ and R² can be organic residues, particularly alkyl or aryl residues, and may be the same or different.

Even more preferably, the drying agent is selected from the group comprising barium, calcium, calcium sulfate, calcium chloride, calcium oxide, sodium sulfate, potassium carbonate, copper sulfate, magnesium perchlorate, magnesium sulfate, lithium chloride and zeolites, and mixtures of two or a plurality of the aforementioned substances. These drying agents offer the advantage of being easily incorporated into the relevant layer of the adhesive tape, having a high sorption capacity, and being renewable drying agents. This is understood to refer to substances that under certain conditions can again release the water and thus return to a state that allows them to be reused for water absorption. This allows a method in which the adhesive tape containing the drying agent, before being brought into contact with the sheet material, can be largely freed of any water it has absorbed up to this point, for example by drying. When the adhesive tape is used, therefore, the full capacity of the drying agent is advantageously available.

In particular, the drying agent is selected from the group comprising calcium oxide, calcium sulfate, calcium chloride, pyrogenic silicas, and zeolites, as well as mixtures of two or a plurality of the aforementioned substances. These materials show particularly high capacities for absorbing water, are largely renewable, can be incorporated into the adhesive tape outstandingly well, and impair the function of the individual layers either not at all or only to a negligible extent.

In a particular embodiment of the invention, the drying agent is selected from calcium oxide, calcium, iron, barium, lithium chloride, and cobalt chloride. By means of changes in their optical properties, these substances allow conclusions to be drawn as to the water content of the sheet material. As long as free drying agent capacity can still be recognized based on the optical appearance of the adhesive tape, this can be taken as an indication that no water, or at the most very little water, is diffused in the sheet material to be protected. Metallic calcium, for example, loses its metallic-opaque appearance and becomes increasingly transparent; cobalt chloride changes its color on absorption of water from blue to pink. The drying agent calcium oxide in particular is used.

Advantageously, the amount of the drying agent in the coating containing the drying agent should be at least 1 wt. %, and preferably at least 10 wt. %, relative in each case to the weight of the layer containing the drying agent. The maximum amount of the drying agent in the layer of the adhesive tape containing the drying agent is limited in each case by the layer-forming properties of the coating material and can be as much as 95 wt. %.

The content essentially depends on the desired capacity for absorbing water.

For example, if only a minor absorption capacity is required, the use of a drying agent in a small amount and with low absorption capacity is sufficient if applicable. In a preferred embodiment, the layer containing the drying agent or layers containing the drying agent therefore contain 1 to 5 wt. % of the drying agent respectively.

In cases where an extremely high absorption capacity of the coating is required, however, a relatively high content of a drying agent must be used in the coating, and the drying agent should also have high absorption capacity. However, even a drying agent with low absorption capacity can be used if this is advisable from the standpoint of cost or compatibility. In a further preferred embodiment of the coating according to the invention, said coating therefore contains 20 to 95 wt. % relative to the entire weight of the coating.

The set layer of the fluid coating material can be permanently or reversibly bonded to the thin sheet glass film. A layer is referred to as reversible when it can be peeled off the glass surface with a force of less than 2 N/cm, preferably less than 1 N/cm, determined on float glass analogously to ISO 29862 (Method 3) at 23° C. and 50% relative humidity at a peeling rate of 300 mm/min and a peeling angle of 180°. Here, an adhesive tape having a correspondingly high adhesive force on the coating is used as a reinforcing tape.

Preferably, in addition to the coating according to the invention, a thin sheet glass film is applied to the thin sheet glass surface to stabilize it, and more preferably, an organic or sol-gel coating is applied to the thin sheet glass surface. The coating also reduces the diffusion of water and water vapor to the glass surface. Organic coatings can also reduce stress corrosion cracking. For example, such coatings are disclosed in H. Furuchi; Glass Technology Vol. 35 (No 6) 1994, pp. 272 to 275; M. Mizuhashi. et. al; Reports Res. Lab. Asahi Glass Co. Ltd.; 36 [1] (1986), pp. 1 to 14, and H. K. Schmidt; 3rd Conference of the European Society of Glass Science and Technology (ESG); Würzburg 1995.

In a preferred improvement of the invention, the coating material contains a silane in addition to the drying agent. Silanes are frequently used in glass substrates in prior art as coupling agents used in order to increase adhesion to glass. Examples are presented in U.S. Pat. No. 6,159,608 B, WO 2008/036222 A, JP 2000003782 A, U.S. Pat. No. 6,501,014 B1, WO 2011/084323 A1, and EP 0924761 A1. In this case, the silane can not only be applied to the glass as a primer prior to coating, but can also be contained in the coating material. Preferably, silanes are used which contain chemical groups that show good compatibility with the coating material or can even form covalent, ionic, or coordinative bonds with the coating material. Preferably, therefore, coatings permanently remaining on the thin sheet glass film should contain a silane.

“Silanes” are understood to refer to compounds of the general formula Rₐ—Si—X₄₋ₐ or partial condensation products thereof. In the formula, a stands for a whole number from 0 through 3 and preferably for 0 or 1. X stands for a hydrolyzable group, for example and preferably a halogen atom, particularly chlorine, an alkoxy group such as a methoxy, ethoxy, n-propoxy, iso-propoxy, n-butoxy, sec-butoxy, or tert-butoxy group, or for an acetoxy group. Further examples of hydrolyzable groups within the meaning of the invention that are known to the person having ordinary skill in the art may also be used. If a plurality of substituents X are present, these substitutes may be the same or different. R stands for an optionally substituted hydrocarbon residue, for example a methyl, ethyl, n-propyl, iso-propyl, n-butyl, sec-butyl, tert-butyl group, a pentyl group and branched isomers thereof, a hexyl group and branched isomers thereof, a heptyl group and branched isomers thereof, an octyl group and branched isomers thereof, a nonyl group and branched isomers thereof, a decyl group and branched isomers thereof, an undecyl group and branched isomers thereof, a dodecyl group and branched isomers thereof, a tetradecyl group and branched isomers thereof, a hexadecyl group and branched isomers thereof, an octadecyl group and branched isomers thereof, or an eicosyl group and branched isomers thereof. The hydrocarbon residues may also include cyclic and/or aromatic components. Representative structures include cyclohexyl, phenyl, and benzyl groups. Optionally, the hydrocarbon residue(s) R contain(s) for example one or a plurality of heteroatom-containing substituents such as amino groups, aminoalkyl groups, glycidyloxy groups, (meth)acryloxy groups and the like. If a plurality of substituents R are present, these may be the same or different.

In a further preferred embodiment of the method according to the invention, a reversible polymeric coating is used that preferably contains a silane that is incompatible with the coating material, i.e. a silane that is incapable of forming covalent, ionic, or coordinative bonds with the coating material. This allows an increase in the adhesion of the reversible coating on the thin sheet glass to be largely prevented. The incompatibility of the silane with the coating material causes the silane molecules capable of migration to accumulate at the interface between the glass and coating and therefore to come into contact with the glass in large numbers. Because of the silane film forming in this manner on the glass, it is even possible to bridge over microcracks and improve glass stability.

In a further preferred embodiment of the method according to the invention, the coating contains a hydrophobic silane, for example octadecyldimethylchlorosilane. Within the meaning of the invention, hydrophobe silanes are defined as silanes with more than ten contiguous carbon atoms.

In a further preferred embodiment of the method according to the invention, an additional coating material with a particularly high permeation barrier for water vapor is arranged on the side of the coating material that is not in contact with the glass.

The additional barrier layer prevents one or a plurality of specific permeates, particularly water vapor, from penetrating into the thin sheet glass composite so that the drying agent contained in the drying agent is not partially or even completely saturated by water diffusing in from the environment.

This type of barrier can consist of organic or inorganic materials, for example a metal layer, an organic layer, or a sol-gel layer.

Particularly preferably, the barrier layer is configured as an inorganic barrier layer. Metals precipitated in a vacuum (for example by means of evaporation, CVD, PVD, PECVD) or at atmospheric pressure (for example by means of atmospheric plasma, reactive corona discharge, or flame pyrolysis), such as aluminium, silver, gold, nickel, or particularly metal compounds such as metal oxides, nitrides, or hydronitrides, for example oxides or nitrides of silicon, boron, aluminium, zirconium, hafnium, tellurium, or indium tin oxide (ITO) are particularly suitable as inorganic barrier layers. Also suitable are layers of the above-mentioned variants doped with further elements.

As an example of particularly suitable methods for the application of an inorganic barrier layer, one can mention high power impulse magnetron sputtering and atomic layer deposition, by means of which it is possible to achieve particularly permeation-resistant layers with low thermal stress of the polymeric coating. Preferred is a permeation barrier of the polymeric coating with an additional water vapor transmission rate (WVTR) of <1 g/(m²*d), and the value refers to the respective thickness of coating used in the sheet material, i.e., is not standardized to a specific thickness. The WVTR is at 38° C. and 90% relative humidity according to ASTM F-1249. In a further preferred embodiment of the invention, after setting, the coating material contains, without the addition of drying agents, less than 500 ppm, and preferably less than 100 ppm of water.

The invention is described by means of two embodiments in five figures. The figures show the following:

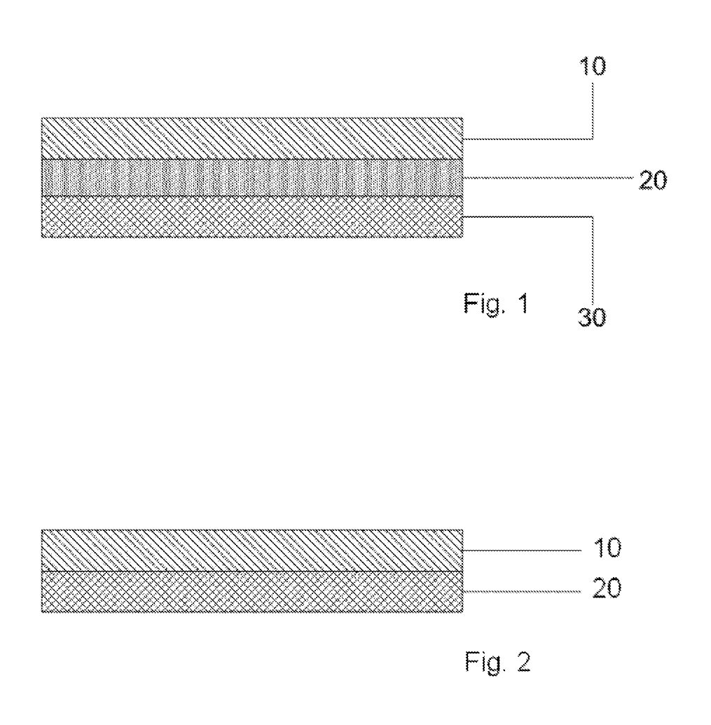

FIG. 1 shows a thin sheet glass composite with a permeation-inhibiting coating that can be rolled up according to the invention,

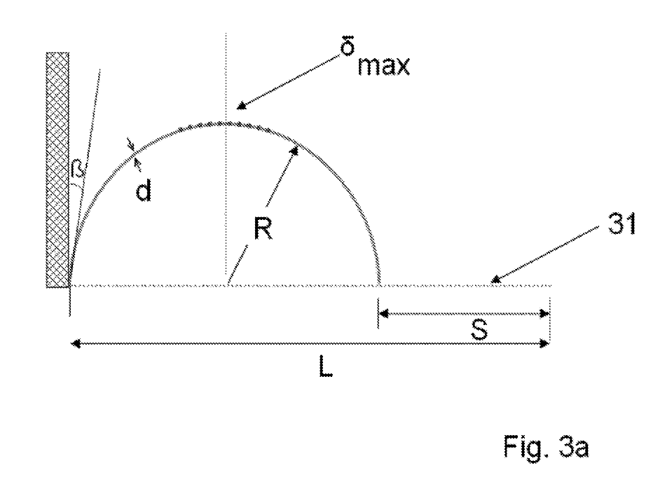

FIG. 2 shows a thin sheet glass composite that can be rolled up,

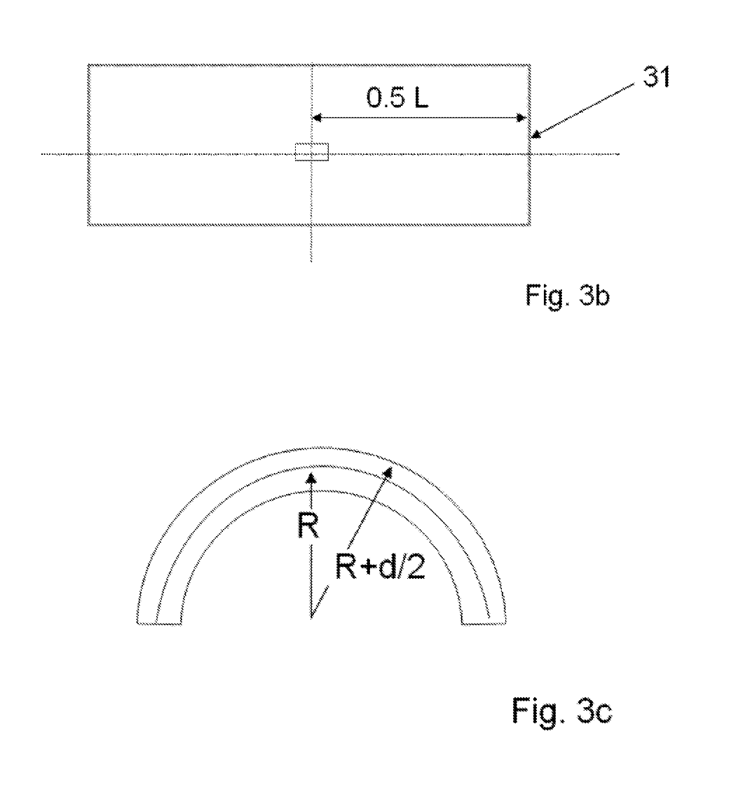

FIG. 3a shows a principle diagram of the bent thin sheet glass composite in the two point bending test,

FIG. 3b shows a schematic view of the strain gauge arranged on the thin sheet glass composite,

FIG. 3c shows a schematic side view of the bent thin sheet glass.

Various coatings filled with drying agents were produced.

### Coating Materials

The following coating materials 20 are used to form the coating according to the invention:

B1: Radiation-crosslinkable acrylate coating material:

| 70 parts | CN307 | POLYBUTADIENE DIMETHACRYLATE |
|---|---|---|
| | | manufactured by Sartomer with a viscosity of 750 |
| | | mPa · s at 60° C. |
| 20 parts | SR833S | TRICYCLODECANE DIMETHANOL DIACRYLATE |
| | | manufactured by Sartomer |
| 5 parts | Irgacure | 500 Photoinitiator manufactured by BASF composed of |
| | | a mixture of 50% 1-hydroxycyclohexylphenylketone |
| | | and benzophenone in a 1:1 ratio |
| 5 parts | Ebecryl | Amino-functionalized acrylate coinitiator |
| | 7100 | |

B2: Radiation-crosslinkable acrylate coating material:

| | | |
|---|---|---|
| 85 parts | Ebecryl 184 | Urethane acrylate oligomer manufactured |
| | | by Cytec containing HDDA |
| 5 parts | HDDA | Hexane diol diacrylate manufactured by |
| | | Cytec |
| 5 parts | lrgacure 500 | Photoinitiator manufactured by BASF |
| | | composed of a mixture of 50% 1- |
| | | hydroxycyclohexylphenylketone and |
| | | benzophenone in a 1:1 ratio |
| 5 parts | Ebecryl 7100 | Amino-functionalized acrylate coinitiator |

B3: Reversible polyisobutylene (PIB) coating material

| | | |
|---|---|---|
| 100 parts | Oppanol B 150 | PIB from BASF, Mn = 425.000 g/mol |

A solution with a PIB content of 10 wt. % is produced. Toluene is used as a solvent.

B4: PVDC coating material

| | | |
|---|---|---|
| 100 parts | Ixan SGA1 | PVDC resin manufactured by Solvay |

A solution with a PVDC content of 25 wt. %. methyl ether ketone is used as a solvent.

In order to produce layers for the determination of the water vapor permeation rate of the coating materials B1-B4, the various coating materials are applied to a polyether sulfone membrane manufactured by Sartorius by means of a laboratory application device in a (dry) layer thickness of approx. 50 μm. The membrane is highly permeable to water vapor. The use of the highly-permeable membrane ensures that only the water vapor permeation rate of the coating is measured.

Samples with the coating materials B1 and B2 are crosslinked in a UV Cube manufactured by Hoenle (mercury medium pressure emitter) with a UV-C-dose of 200 mJ/cm² (250 to 260 nm band).

Drying of the coating materials B3 and B4 is carried out in each case at 120° C. for 30 min in a laboratory drying cabinet.

The water vapor permeation rate (WVTR) is measured at 38° C. and 90% relative humidity according to ASTM F-1249. The indicated value is the average of two measurements.

| Name | WVTR [g/m² d] |
|---|---|
| B1 | 34 |
| B2 | 286 |
| B3 | 8 |
| B4 | 3 |

The following drying agents are used:

| Name | Description | Brand name | Supplier |
|---|---|---|---|
| G1 | Calcium oxide | Calcium oxide nanopowder | Sigma-Aldrich |
| G2 | Zeolite 3A | Purmol 3 STH | Zeochem |

The drying agents are incorporated into the coating materials B1-B4 using a high-speed dispersion disk of a laboratory centrifuge. The coating materials are first dried by means of approx. 1 mm zeolite spheres, which are again filtered out before the coating process.

As a thin sheet glass film, a glass of the type D263 T eco manufactured by Schott, Mainz with a thickness of 70 μm and a length of 100 mm was used, and the width was also 100 mm.

Coating onto the thin sheet glass film 10 is carried out analogously to coating onto the membrane. As a permeation-inhibiting additional barrier layer 30, in example V9 a film provided with an inorganic barrier layer manufactured by Toppan is laminated onto the coating B2 before curing. UV irradiation is carried out through the film.

| | | | | Thickness | WVTR |
|---|---|---|---|---|---|
| Name | Description | Brand name | Supplier | [μm] | [g/m²d] |
| T1 | polyester film with | GX-P-F | Toppan | 30 | 0.13 |
| | organic barrier | | Printing | | |
| | layer | | | | |

As a comparison example, a coating is produced with the coating material 20 B2 produced that contains no drying agent and has a water vapor permeation rate of more than 50 g/m²d.

TABLE 1
Coatings in the method according to the invention:

| | | | Content of | Coating | |
|---|---|---|---|---|---|
| | Coating | Drying | drying agent | thickness | Barrier |
| Name | material | agent | (wt. %) | [μm] | layer |
| V1 | B1 | G1 | 10 | 100 | — |
| V2 | B2 | G1 | 50 | 100 | — |
| V3 | B3 | G1 | 10 | 100 | — |
| V4 | B4 | G1 | 10 | 100 | — |
| V5 | B1 | G2 | 10 | 100 | — |
| V6 | B2 | G2 | 50 | 100 | — |
| V7 | B3 | G2 | 10 | 100 | — |
| V8 | B4 | G2 | 10 | 100 | — |
| V9 | B2 | G2 | 10 | 100 | T1 |
| C1 | B2 | — | 0 | 100 | — |

With the drying agent contents shown, all of the coating materials 20 showed a viscosity according to DIN 53019-1 at a measuring temperature of 23° C. and a shear rate of 1 s⁻¹ in use of a standard cylinder geometry of below 10,000 mPa·s.

After drying of the coating, the minimum bending radius R is determined immediately after production.

Intermediate storage of the coatings on thin sheet glass films V1-V8 and the comparison sample C1 is carried out immediately after their production for 2 hours at 40° C. and 90% relative humidity with a bending radius R of 100 mm, with the thin sheet glass film 10 located on the inner side of the radius R, so that the side of the thin sheet glass film 10 which is subjected to the greatest tensile stress is covered with the coating of the coating material 20 containing a drying agent. This simulates the time between the production of a wound-up composite and the packing of the roll.

After this, the composite is stored in a permeation-tight package (welded into a aluminum composite film) at 60° C. for another 60 days with a bending radius R of 100 mm, with the thin sheet glass film 10 again lying on the inner side of the radius R. The minimum bending radius R is then determined. Determination of the water content is also carried out after this storage period of 60 days.

For sample V9, intermediate storage of the coating on the thin sheet glass film is carried out immediately after it is produced for 14 days at 40° C. and 90% relative humidity with a bending radius R of 100 mm, with the thin sheet glass film 10 lying on the inner side of the radius R. This simulates a longer time between the production of a wound-up composite and the packing of the roll. The further procedure is the same as for the other samples.

Moreover, the reversibility of coating of the thin sheet glass film 10 is subjectively assessed by means of manual peel-off experiments. For this purpose, the composite is glued with its glass side by means of strongly adhesive tape (tesa 4972) to a steel plate, the coating is pulled up beginning from the corner using a gripper attached using the same adhesive tape.

TABLE 2
Results of the method

| | Water | | Bending | Bending |
|---|---|---|---|---|
| | content of | | radius | radius |
| | polymer | Reversibility | without | after |
| | coating | + detachable as a layer | storage | storage |
| Example | [ppm] | − nondetachable | [mm] | [mm] |
| V1 | 15 | − | 28 | 32 |
| V2 | 26 | − | 31 | 38 |
| V3 | 11 | + | 32 | 31 |
| V4 | 9 | − | 30 | 31 |
| V5 | 11 | − | 28 | 33 |
| V6 | 114 | − | 33 | 40 |
| V7 | 8 | + | 32 | 34 |
| V8 | 9 | − | 29 | 30 |
| V9 | 18 | − | 31 | 30 |
| C1 | 1320 | − | 28 | 45 |

The results show that with the method according to the invention, the thin sheet glass film 10 can be outstandingly protected. On the average, the coated thin sheet glass films 10 accordingly to the invention show virtually no increase in the minimum bending radius R, while the comparison example shows a significant increase.

In this case, the permeation-inhibiting additional barrier layer 30 (V9) is particularly suitable, as it considerably reduces the diffusion of humidity into the composite 31, and therefore has a lower minimum bending radius R than the corresponding sample without the permeation-inhibiting additional layer 30 (V6) despite the longer storage time and lower content of getter material. The use of the strongly permeation-inhibiting coating material 20 (B3 and B4) also provides advantages compared to the more permeable coating material 20.

The water content of the coating materials 20 after storage is determined according to DIN 53715 (Karl Fischer titration). The measurement takes place in a Karl Fischer Coulometer 851 in combination with an oven sampler (oven temperature 140° C.). With a starting weight of approx. 0.5 g of the composite, threefold determination is carried out in each case, with the water content relating in each case only to the amount of the coating material, as it is assumed that the glass itself does not absorb any relevant amount of water. The arithmetic mean of the measurements is given as the water content.

It is found that the getter material in the coating material significantly reduces the amount of water to which the glass is exposed, and that this has a clear effect on the minimum bending radius.

The determination of the minimum bending radius R takes place by means of the two point bending test. The test method is based on the Corning method published by S.T. Gulati and the Patent WO 2011/084323 A1 (Gulati et al., ID Symposium Digest of Technical Papers, Vol. 42, Issue 1, pages 652 to 654, June 2011).

In order to eliminate edge effects, a stabilized strip approx. 10 mm wide of the adhesive tape tesa 50575 (80 μm thick aluminium film with an acrylate pressure-sensitive adhesive) is applied along both edges of the thin sheet glass film transversely to the bending axis so that it protrudes approx. 1 mm over the glass edge. These aluminium strips come to rest during the bending test on the outer side of the bending radius and cause the glass edge to be kept under compressive stress, thus sharply reducing the risk of cracks originating there.

The flexibility of the coated glass can be characterized by the two point bending test. In this case, the minimum bending radius R is measured and calculated in mm shortly before or exactly at the moment of breakage. The laminate has the coating side facing upward and is fixed on one side. The other side is displaced at a rate of 10 mm/min in the direction of the fixed end. The resulting bending radius R is measured or calculated from the elongation. The test structure for the two point bending test is shown in FIG. 3a. A dotted line represents the position and length L of the coated thin sheet glass 31 before bending. The solid line schematically indicates the position of the coated thin sheet glass 31 at the minimum bending at the moment of the first crack occurring transversely to the direction of movement.

L is the length of the coated thin sheet glass 31, and s is the distance the one end of the coated thin sheet glass 31 has traveled during the bending process until breakage. The thickness of the coated thin sheet glass is indicated by d, and β is the contact angle required for calculating the bending stress δ. As the contact angle β decreases, i.e. as the radius R decreases, the stress on the glass increases.

The experiment is recorded in a side view using a videocamera. The radius R is measured at the moment of breakage using the device shown in the figure or calculated using the formula below. The bending elongation ε required for calculating the bending radius R is calculated using a strain gauge.

FIG. 3b shows the arrangement of the strain gauge in the center of the thin sheet glass composite 31.

The bending radius R is calculated from the measured bending elongation ε as follows:

$$\frac{R}{R + \frac{d}{2}} = \frac{L}{L + Δ L}$$

$$\frac{R}{R + \frac{d}{2}} = \frac{1}{1 + \frac{Δ L}{L}} = \frac{1}{1 + ɛ}$$

$$R + R ɛ = R + \frac{d}{2}$$

$$R = \frac{d}{2 ɛ}$$

With the bending elongation ε=ΔL/L, L: original length and length of the medium phase of the thin sheet glass composite 31 with radius R, and ΔL corresponds to the change in length of the outer phase of the thin sheet glass composite 31 with radius R+d/2 in FIG. 3c.

As the minimum bending radius R of Table 2, the median value of 15 measurements is given.

### Measurement Methods

### Molecular Weight

The molecular weight determinations of the number average molecular weights Mₙ and the weight average molecular weights M_{w} (or the other molecular weights) were carried out by means of gel permeation chromatography (GPC). THF (tetrahydrofuran) with 0.1 vol.-% of trifluoroacetic acid was used as an eluent. Measurement was carried out at 25° C. The PSS-SDV, 5μ, 10³ Å, ID of 8.0 mm×50 mm, was used as a precolumn. The columns PSS-SDV, 5μ, 10³, 10⁵, and 10⁶ with ID of 8.0 mm×300 mm respectively were used for separation. The sample concentration was 4 g/l, the flow rate was 1.0 ml per minute. Measurement was conducted against polystyrene standards.

### LIST OF REFERENCE NUMBERS

10 Thin sheet glass film
20 Polymeric coating material
30 Additional barrier layer
31 Thin sheet glass composite
d Thickness of the thin sheet glass composite
l Drying agent
s Displacement of the thin sheet glass composite
L Length of the thin sheet glass composite
R Radius/bending radius
β Contact angle
δ Bending stress
ε Bending elongation

1. A method for storing a thin sheet glass film wherein, according to the method, the thin sheet glass film is held at two sides, at least one side of the thin sheet glass film is coated with a fluid coating material comprising at least one drying agent present upon its surface, the coating material on the at least one side of the thin sheet glass film sets to form a solid polymeric coating, and wherein the coated thin sheet glass film is rolled up for storage.

2. The method according to claim 1, wherein the coated thin sheet glass film is rolled up in such a way that the radial outer side of the rolled up thin sheet glass film is coated with the polymeric coating.

3. The method according to claim 1, wherein, a solution, dispersion, or melt of the polymer is used as a coating material.

4. The method according to claim 1, wherein the structural components of polymers are applied to the at least one side of the thin sheet glass film, and energy is transmitted to the applied structural components, and the structural components react to form a coating material.

5. The method according to claim 1, wherein the coating material has a viscosity of more than 1 mPa·s and less than 10⁸ Pa·s.

6. The method according to claim 1, wherein and additional, permeating-inhibiting barrier layer is applied to the side of the polymeric coating facing away from the thin sheet glass film.

7. The method according to claim 1, wherein the polymeric coating is peeled from the at least one side of the thin sheet glass film.

8. The method according to claim 1, wherein the one side of the thin sheet glass film is coated with a silane-containing coating material and the polymeric coating remains permanently on the thin sheet glass film.

9. The method according to claim 1, wherein the polymeric coating is reversibly bonded to the thin sheet glass film.

10. A rolled up thin sheet glass composite which comprises:
a thin sheet glass film having two sides and
a polymeric coating over its entire surface comprising at least one drying agent, which sets on at least one of the sides and is in direct contact with at least one side of the thin sheet glass film over its entire surface and is present upon the radial outer side of the thin sheet glass film.

11. A rolled up thin sheet glass composite according to claim 10, which further comprises an additional permeation-inhibiting barrier layer (30) is present upon the entire surface of a side of the polymeric coating facing away from the thin sheet glass film (10).

12. The method according to claim 5, wherein the coating material has a viscosity of more than 1 mPa·s and less than 10⁵ Pa·s.

13. The method according to claim 12, wherein the coating material has a viscosity of more than 1 mPa·s and less than 10 Pa·s.
